(19) United States
(12) Patent Application Publication
(10) Pub. No.: US 2026/0352130 A1
(43) Pub. Date: Nov. 5, 2026

(54) BI-DIRECTIONAL HUMAN-MACHINE INTERFACE

(71) Applicant: KA GROUP AG, Zurich (CH)

(72) Inventors: Bengt Cyren, Svanesund (SE); Andreas Kammensjo, Bankeryd (SE); David Blank, Mullsjo (SE)

(21) Appl. No.: 19/485,863

(22) PCT Filed: May 24, 2023
(86) PCT No.: PCT/IB2023/055347

§ 371 Date: Nov. 19, 2025

(51) Int. Cl. H02P 25/032

(52) U.S. Cl. CPC H02P 25/032

(57) ABSTRACT

A bi-directional human-machine interface may provide electromotive force to move a dynamic component toward a predetermined alignment providing visual feedback to a human operator and may provide electromotive force to provide position stability and virtual detent tactile feedback to the human user when manually positioned.

### CROSS-REFERENCE TO RELATED APPLICATIONS

This application claims priority to International Application No. PCT/IB2023/055347, filed May 24, 2023, the contents of which are incorporated herein by reference in their entirety.

### INTRODUCTION

The subject disclosure relates to human interaction with apparatus, including mechanical, electrical and hybrid mechanical/electrical apparatus. Generally, some human interaction with an apparatus is required for conveying information from a user to the apparatus and from the apparatus to the user.

### SUMMARY

In one exemplary embodiment, a bi-directional human-machine interface may include an electric motor having a static component fixedly attached to a support and a dynamic component moveable with respect to the support, a plurality of alignments of the dynamic component to the static component, wherein the alignments are visually discernable via alignment of a visible index on the dynamic component to respective visible indices on the support, and a controller configured to provide an electromotive force from the static component to the dynamic component, the controller operable in a first mode to control the electromotive force effective to move the dynamic component toward a predetermined one of the plurality of alignments in response to a deviation of the dynamic component from the predetermined one of the plurality of alignments, and operable in a second mode to control the electromotive force effective to provide position stability and virtual detent tactile feedback to a human user corresponding to at least one of the plurality of alignments in response to a manual positioning of the dynamic component by the human user to the at least one of the plurality of alignments.

In addition to one or more of the features described herein, the electric motor may include a rotary electric motor.

In addition to one or more of the features described herein, the electric motor may include a linear electric motor.

In addition to one or more of the features described herein, the plurality of alignments may correspond to a plurality of automotive transmission settings and the predetermined one of the plurality of alignments may correspond to one of the plurality of automotive transmission settings activated by an autonomous driving system.

In addition to one or more of the features described herein, the controller configured to provide the electromotive force may include a primary force module providing a primary force signal, wherein the electromotive force may be provided based upon the primary force signal.

In addition to one or more of the features described herein, the primary force module providing the primary force signal may include a plurality of force signal profiles selectively invoked to provide the primary force signal.

In addition to one or more of the features described herein, the plurality of force signal profiles may include at least one respective force signal profile providing the primary force signal in the first mode in response to the deviation of the dynamic component from the predetermined one of the plurality of alignments.

In addition to one or more of the features described herein, the plurality of force signal profiles may include at least one respective force signal profile providing the primary force signal in the second mode in response to the manual positioning of the dynamic component by the human user to the at least one of the plurality of alignments.

In addition to one or more of the features described herein, the controller configured to provide the electromotive force may further include a dynamics force module providing a virtual dynamics force signal, wherein the electromotive force may be provided further based upon the virtual dynamics force signal.

In addition to one or more of the features described herein, the dynamics force module providing the virtual dynamics force signal may include a virtual mass viscous damping force module providing a virtual mass viscous damping force signal and a virtual reaction force module providing a virtual reaction force signal, wherein the virtual dynamics force signal may be provided based upon the virtual mass viscous damping force signal and the virtual reaction force signal.

In addition to one or more of the features described herein, the controller configured to provide the electromotive force may further include a haptic force module providing a haptic force signal in response to the manual positioning of the dynamic component by the human user, and wherein the electromotive force may be provided further based upon the haptic force signal.

In addition to one or more of the features described herein, the controller configured to provide the electromotive force may further include a fine grain force module providing a fine grain force signal in response to the manual positioning of the dynamic component by the human user, wherein the electromotive force is provided further based upon the fine grain force signal.

In another exemplary embodiment, a bi-directional human-machine interface, may include a rotary electric motor having a static component fixedly attached to a support in a vehicle and a dynamic component rotatable with respect to the support, a plurality of alignments of the dynamic component to the static component corresponding to a plurality of automotive transmission settings, wherein the alignments are visually discernable via alignment of a visible index on the dynamic component to respective visible indices on the support, a controller configured to provide an electromotive force from the static component to the dynamic component, the controller operable in a first mode to control the electromotive force effective to move the dynamic component toward a predetermined one of the plurality of alignments corresponding to one of the plurality of automotive transmission settings activated by an autonomous driving system in response to a deviation of the dynamic component from the predetermined one of the plurality of alignments, and operable in a second mode to control the electromotive force effective to provide position stability and virtual detent tactile feedback to a human user corresponding to at least one of the plurality of alignments in response to a manual positioning of the dynamic component by the human user to the at least one of the plurality of alignments.

In addition to one or more of the features described herein, the controller configured to provide the electromotive force may include a first force module providing a primary force signal and a second force module providing a virtual dynamics force signal, wherein the electromotive force is provided based upon the primary force signal and the virtual dynamics force signal.

In addition to one or more of the features described herein, the first force module providing the primary force signal may include a plurality of force signal profiles selectively invoked to provide the primary force signal.

In addition to one or more of the features described herein, the plurality of force signal profiles may include at least one respective force signal profile providing the primary force signal in the first mode in response to the deviation of the dynamic component from the predetermined one of the plurality of alignments.

In addition to one or more of the features described herein, the plurality of force signal profiles may include at least one respective force signal profile providing the primary force signal in the second mode in response to the manual positioning of the dynamic component by the human user to the at least one of the plurality of alignments.

In addition to one or more of the features described herein, the second force module providing the virtual dynamics force signal may include a virtual mass viscous damping force module providing a virtual mass viscous damping force signal and a virtual reaction force module providing a virtual reaction force signal, wherein the virtual dynamics force signal is provided based upon the virtual mass viscous damping force signal and the virtual reaction force signal.

In addition to one or more of the features described herein, the controller configured to provide the electromotive force may further include a third force module providing a haptic force signal in response to the manual positioning of the dynamic component by the human user, wherein the electromotive force is provided further based upon the haptic force signal.

In yet another exemplary embodiment, a bi-directional human-machine interface may include a rotary electric motor having a static component fixedly attached to a support in a vehicle and a dynamic component rotatable with respect to the support, a plurality of alignments of the dynamic component to the static component corresponding to a plurality of automotive transmission settings, wherein the alignments are visually discernable via alignment of a visible index on the dynamic component to respective visible indices on the support, and a controller configured to provide an electromotive force from the static component to the dynamic component, the controller operable in a first mode to control the electromotive force effective to move the dynamic component toward a predetermined one of the plurality of alignments corresponding to one of the plurality of automotive transmission settings activated by an autonomous driving system in response to a deviation of the dynamic component from the predetermined one of the plurality of alignments, and operable in a second mode to control the electromotive force effective to provide position stability and virtual detent tactile feedback to a human user corresponding to at least one of the plurality of alignments in response to a manual positioning of the dynamic component by the human user to the at least one of the plurality of alignments. The controller may include a first force module having a plurality of selectively invoked force signal profiles providing a primary force signal, wherein the plurality of selectively invoked force signal profiles includes at least one respective force signal profile providing the primary force signal in the first mode in response to the deviation of the dynamic component from the predetermined one of the plurality of alignments and at least one respective force signal profile providing the primary force signal in the second mode in response to the manual positioning of the dynamic component by the human user to the at least one of the plurality of alignments, a second force module providing a virtual dynamics force signal, wherein the second force module may include a virtual mass viscous damping force module providing a virtual mass viscous damping force signal and a virtual reaction force module providing a virtual reaction force signal, wherein the virtual dynamics force signal is provided based upon the virtual mass viscous damping force signal and the virtual reaction force signal, and a third force module providing a haptic force signal in response to the manual positioning of the dynamic component by the human user, wherein the electromotive force is provided from the static component to the dynamic component based upon the primary force signal, the virtual dynamics force signal and the haptic force signal.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A is a schematic illustration of a top down view of a human-machine interface, in accordance with the present disclosure;

FIG. 1B is a schematic sectional illustration of a human-machine interface, in accordance with the present disclosure;

FIG. 2 is a schematic illustration of a human-machine interface, in accordance with the present disclosure; and

FIG. 3 is an exemplary control scheme for a human-machine interface, in accordance with the present disclosure.

### DETAILED DESCRIPTION

The following description is merely exemplary in nature and is not intended to limit the present disclosure, its application or uses. Throughout the drawings, corresponding reference numerals indicate like or corresponding parts and features.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components (e.g., memory elements, digital signal processing elements, logic elements, look-up tables, or the like) which may carry out a variety of functions under the control of one or more microprocessors or other control devices.

As used herein, electronic control unit (ECU), control module, module, control, controller, control unit, electronic control unit, processor and similar terms may refer to any hardware, software, firmware, electronic control component, processing logic, and/or processor device, individually or in any combination. In various embodiments, a control module may include any one or various combinations of one or more of Application Specific Integrated Circuit(s) (ASIC), electronic circuit(s), central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, and in-plant and service-related networks including for over the air (OTA) software updates. Functions of a control module as set forth in this disclosure may be performed in a distributed control architecture among several networked control modules. Software, firmware, programs, instructions, routines, code, algorithms and similar terms mean any controller executable instruction sets including calibrations, data structures, and look-up tables. A control module may have a set of control routines executed to provide described functions. Routines are executed, such as by a central processing unit, and are operable to monitor inputs from sensing devices and other networked control modules and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests.

Conventional techniques related to signal processing, data transmission, signaling, control, machine learning models, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

A bi-directional human-machine interface (HMI) is disclosed in an embodiment related to a vehicle and may hereafter be referred to as HMI. Vehicle is understood to refer to any means of transportation including non-limiting examples of motorcycles, cars, trucks, buses, excavation, earth moving, construction and farming equipment, railed vehicles like trains and trams, aircraft, and watercraft like ships and boats. An exemplary vehicle may include an automobile including a body, chassis, and wheels, each of which are rotationally coupled to the chassis near a respective corner of the body. The vehicle may be a four wheel vehicle, but the number of wheels may vary in other embodiments. The vehicle may be autonomous or semi-autonomous. The vehicle may include an electrical system and drive system, which generally may include known vehicle systems for vehicle operation, such as, a propulsion system, a transmission system, a steering system, and a brake system, and generates or senses a variety of signals, including vehicle speed, vehicle direction, brake pedal apply, and autonomous operation commands, among others. In various embodiments, the electrical system and drive system may be operatively coupled to one or more onboard components and systems via a communication bus. Signals may be available over a vehicle bus for use by a variety of controls and diagnostics. The propulsion system may generate propulsion torque with an internal combustion engine, electric motors or a combination thereof. It is understood, however, that such an embodiment is merely exemplary and not limiting and a bi-directional human-machine interface may find application in other vehicles as well as other applications.

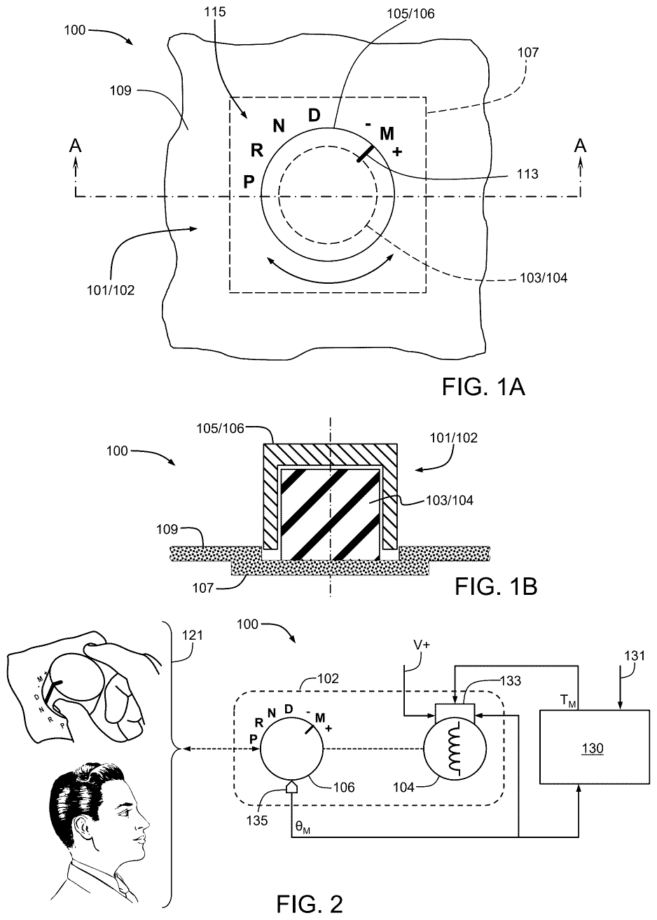

FIG. 1A schematically illustrates a top down view of an embodiment of an HMI 100 and FIG. 1B schematically illustrates the HMI 100 in section taken along line A-A in FIG. 1A. HMI 100 may include an electrical motor 101 (motor 101) including a static component 103 and a dynamic component 105. In the illustrated embodiment, the motor 101 is an interior-stator 104 rotary motor 102 wherein the static component 103 may include the stator 104 and the dynamic component 105 may include an exterior-rotor 106. In an alternate embodiment, the motor 101 may be a linear motor. The motor 101 may be any suitable variety including brushless permanent magnet or switched reluctance motors. In an embodiment, the HMI 100 may include a printed circuit board (PCB) 107 fixedly attached to the stator 104. The PCB 107 may also carry circuit components for electric power distribution, control and sensing related to the motor 102 as further described herein. The PCB 107 may be fixedly attached to a support 109 such that the stator 104 is fixed relative to the support 109. In an embodiment, the support 109 may be a center console in a vehicle and the location of the HMI 100 may be forward of an armrest and visually unobstructed to a vehicle operator. In an embodiment, the support 109 may be an instrument panel of a vehicle or any other suitable fixed location within a vehicle readily accessible and visible to a vehicle operator. The HMI 100 may include a visible index 113 such as a line, dot, arrow, letter, number, symbol or other marking or feature that travels with the displacement of the rotor 106. Such index associated with the rotor 106 may be referred to as a rotor index. The HMI 100 may further include a plurality of visible indices 115 such as lines, dots, arrows, letters, numbers, symbols or other marking or feature that remain fixed relative to the support 109 and stator 104. Such indices associated with the support 109 may be referred to as support indices. In the present embodiment illustrated, the visible indices 115 include the letters P, R, N and D representing vehicle powertrain transmission states of park, reverse, neutral and drive, respectively. The visible indices 115 may also include the letter M flanked by minus (−) and plus (+) signs representing a manual vehicle powertrain transmission state allowing manual incrementing and decrementing of transmission speed ratios. Alignment of the index 113 with one of the indices 115 may represent a current state of the vehicle powertrain transmission. In operation, the rotor 106 may be manually operated and positioned to select vehicle powertrain transmission states by aligning the index 113 with the indices 115. In operation, the rotor 106 may be electromechanically operated and positioned to indicate vehicle powertrain transmission states by aligning the index 113 with the indices 115.

FIG. 2 schematically illustrates the HMI 100 including the motor 102. The motor 102 includes the stator 104 operatively coupled to the rotor 106. A human user 121 may interact with the HMI 100 through manual positioning of the rotor 106 and visual observation of automated electromechanical operation of the rotor 106. A controller 130 may be signally connected to vehicle information signals via bus 131 or discrete communication lines. For example, the controller circuitry (controller) 130 may receive information signals relative to vehicle dynamics (e.g., speed and direction), brake and accelerator pedal positions, vehicle moding (e.g., on/off, manual/autonomous, etc.) and other vehicle related information signals. The motor 102 may have associated power switching electronics such as solid state drive circuitry (driver) 133 which provides direct current (DC) electrical power to the stator 104 as further described herein. The motor 102 may also have rotor angular position signal (θ_{M}) provided by rotational sensor 135 (e.g., hall effect sensor including magnet and processing circuit). The driver 133 and rotational sensor 135 are schematically illustrated as part of the motor 102; however, the driver 133 and rotational sensor 135 may be integrated as part of the controller 130. In an embodiment, the controller 130, rotational sensor 135 and driver 133 may integrated to and share the mounting structure of the PCB 107 with the stator 104 as described herein. The driver 133 may receive electrical power via a DC voltage source V+ (e.g., vehicle low voltage auxiliary load voltage source) and energize one or more phase windings of the stator 104 in accordance with the rotor angular position signal (θ_{M}) and a motor torque signal T_{M} from the controller 130 as further described herein.

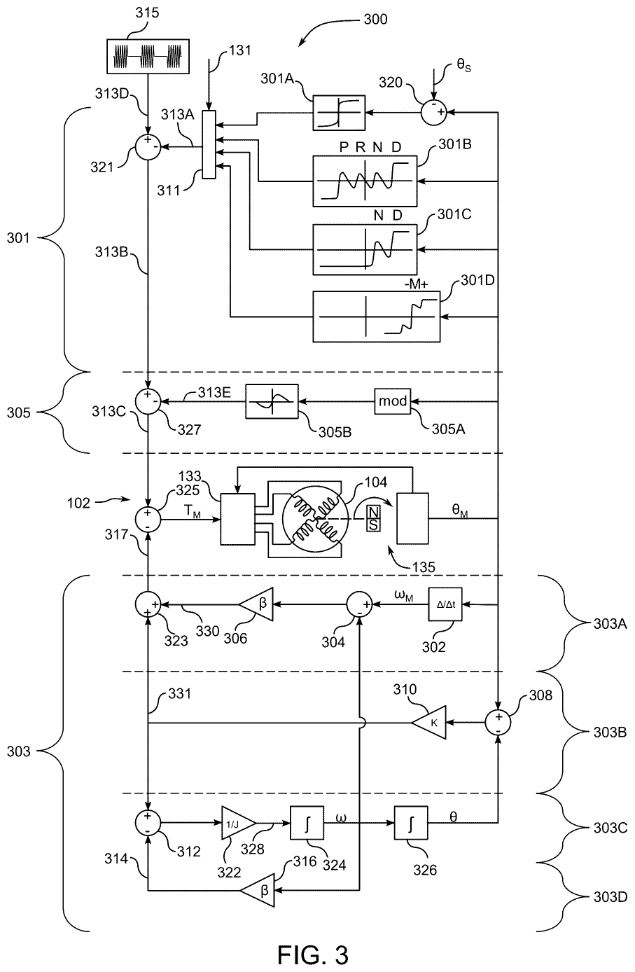

With reference to FIG. 3, an exemplary control scheme 300 for the HMI 100 described herein in conjunction with FIGS. 1A, 1B and 2 is represented in a block diagram of relationships and flows among functional modules. The control scheme may be implemented in one or more processors as further described herein. In one embodiment, control scheme 300 may be implemented in a computer program (or “application”) embodied in a computer readable medium and including instructions usable by one or more processors of one or more computers of one or more systems. The computer program may include one or more software programs including program instructions in source code, object code, executable code or other formats; one or more firmware programs; or hardware description language (HDL) files; and any program related data. The data may include data structures, libraries, look-up tables, or data in any other suitable format. The program instructions may include program modules, routines, programs, objects, components, or the like. The computer program may be executed on one computers or on multiple computers in communication with one another. In an embodiment, the controller 130 shown in FIG. 2 performs the functions of the modules described herein.

FIG. 3 schematically illustrates the motor 102 (centrally in the figure) previously described including the rotor 104, driver 133 and rotational sensor 135 providing the rotor angular position signal (θ_{M}) as used in the control scheme 300. The control scheme 300 provides the driver 133 of the motor 102 with a motor torque signal T_{M} and the rotor angular position signal (θ_{M}) used by the driver to provide an electromotive force from the stator 104 to the rotor 106 (FIG. 2). As previously described, the rotor 106 may be electromechanically operated and positioned to indicate vehicle powertrain transmission states. Such operation may correspond to a first mode of operation wherein the various vehicle operating tasks may be under automated control of an autonomous driving system. For example, control of the vehicle may be released to an autonomous driving system by the human user 121 to perform the tasks associated with parallel parking which may include pulling forward next to an adjacent vehicle, reverse travel and steering, additional repetitive forward and reverse travel with steering, and finally entering a park state. The rotor 106 may also be manually operated and positioned to select vehicle powertrain transmission states. Such operation may correspond to a second mode of operation wherein the various vehicle operating tasks, at least with respect to vehicle powertrain transmission state selections, remain under manual control by the human user 121. Thus, for example, the first and second mode may be mutually exclusive and determined for the present purposes based at least upon whether the vehicle is in a manual mode or autonomous mode as may be conveyed by information signals including signals from an autonomous driving system over the bus 131, for example.

In an embodiment, a primary force module 301 selectively determines a primary force signal 313A in the first mode and the second mode of operation. The primary force module 301 may include a plurality of selectively invoked force signal profiles 301A-301D, each of which represents a corresponding mapping of force signals for motor control. The force signal profiles 301A-301D may be implemented, for example, in one-dimensional look-up tables based upon a rotor angle metric. In the case of a first mode operation (e.g., autonomous operation), the force signal profile 301A may provide the primary force signal. In the case of a second mode of operation (e.g., manual operation), the force signal profiles 301B-301D may selectively provide the primary force signal.

In an embodiment, the control scheme 300 in the first mode of operation may control the electromotive force of the motor 102 to move the rotor 106 toward alignment of the rotor index with a support index. Thus, in the example of an autonomous parallel parking maneuver, the human user 121 would observe movement of the rotor 106 and alignment of the rotor index with the support index corresponding to the currently activated vehicle powertrain transmission state. The human operator would therefore observe the index alignments changing between D and R on the support 109 as the autonomous parallel parking maneuver manages the vehicle powertrain transmission state between drive and reverse. At the end of the autonomous parallel parking maneuver, the human operator would observe movement of the rotor 106 to the index alignment corresponding to P on the support 109 as the vehicle powertrain transmission state moved into park. Each of the support indices corresponds to a vehicle powertrain transmission state and to a unique rotor angle. Therefore, a rotor angle setting (θ_{S}) may be provided to the control scheme 300 at node 320 and the difference or deviation (Δ) from the rotor angular position signal (θ_{M}) determined. This deviation (Δ) is then used to reference the force signal profile 301A which provides the primary force signal 313A in the first mode.

In an embodiment, the control scheme 300 in the second mode of operation may control the electromotive force of the motor 102 to provide position stability and virtual detent tactile feedback to the human user 121 as the rotor is manually moved to and through the various index alignments P, R, N, D and M on the support 109 corresponding to the vehicle powertrain transmission states of park, reverse, neutral, drive and manual, respectively. Thus, the human user 121 may observe, through tactile feedback through the rotor 106 corresponding to the operative force signal profile, virtual detents at the available index alignments. The human operator would therefore observe the rotor's preference for and stability in the various available index alignments. Similarly, the operator may observe increased resistance and opposing force when attempting to manually move outside of available index alignments. Upon manually achieving an index alignment, the human operator feels confident through the detent feedback the index alignment is stable and the rotor may be released. Again, each of the support indices corresponds to a vehicle powertrain transmission state and to a unique rotor angle. In the case of second mode operation, multiple rotor angles may correspond to available index alignments and vehicle powertrain transmission states. The rotor 106 thus may be manually moved to one of several stable index alignments. Therefore, the rotor angular position signal (θ_{M}) may be provided to the control scheme 300 and used to reference the force signal profiles 301B-301D which selectively provide the primary force signal 313A in the second mode.

In an embodiment, the control scheme 300 may include an arbitration block 311 which determined which of the plurality of force signal profiles 301A-301D provides the primary force signal 313A. As previously set forth herein, the bus 131 may provide various information signals relative to vehicle dynamics (e.g., speed and direction), brake and accelerator pedal positions, vehicle moding (e.g., on/off, manual/autonomous, etc.) and other vehicle related information signals. Such bus data may be available to the arbitration block 311. In addition, the rotor angular position signal (θ_{M}) may be provided to the arbitration block. Thus, the arbitration block 311 may select the force signal profile 301A-301D to be used in determining the primary force signal 313A. For example, an active autonomous driving mode as conveyed by signals from an autonomous driving system over the bus 131 may itself be determinative of the use of the force signal profile 301A dependent upon the deviation (Δ) of the rotor angular position signal (θ_{M}) from the rotor angle setting (θ_{S}) to determine the primary force signal 313A. However, in the absence of an active autonomous driving mode, a manual driving mode is assumed and additional considerations and arbitrations may be required to select the force signal profile 301B-301D to be used in determining the primary force signal 313A. For example, the vehicle may be on or propulsion ready, the rotor angular position signal (θ_{M}) may be indexed to park and the vehicle speed zero. However, an electronic brake-transmission shift interlock may prevent the selection of any force signal profile 301B-301D until the brake pedal is depressed. Instead, the force signal profile 301A or similar may provide the primary force signal 313A to effectively resist manual movement of the rotor 106 out of the park index and to return the rotor 106 back to the park index if so moved. Moreover, a haptic force module 315 may provide haptic feedback to the human user 121 through the addition of a haptic force signal 313D to the primary force signal 313A at node 321 of a rapid succession of vibratory torque signatures, thumping or other tactile feedback as corrections to the human user 121 in persistent invalid attempts at moving the rotor 106. The output from node 321 is the primary force signal 313B which is input to node 327. Assuming brake application, the arbitration block 311 may select force signal profile 301B which allows manual positioning of the rotor 106 to park, reverse, neutral or drive index alignments (PRND). However, once the vehicle speed is non-zero and direction of travel is forward, the arbitration block 311 may select force signal profile 301C to provide the primary force signal 313A which removes availability of park and reverse index alignments as valid and may effectively resist manual movement of the rotor 106 out of the neutral index toward reverse and park indices and to return the rotor 106 back to the neutral index if so moved. Again, the haptic force module 315 may provide haptic feedback in the haptic force signal 313D to the human user 121 as corrections in persistent invalid attempts at moving the rotor 106. Arbitration block 311 may continue to similarly evaluate these and additional relevant information signals such as current transmission speed ratio, transmission temperature, user preferences and others in the selection of an appropriate force signal profile including force signal profile 301D which provides a stable position at the manual index alignment and flanking tactile detents on either side thereof for indicating transmission speed ratio increments and decrements in a manual shifting mode. Additional force signal profiles may be apparent to one having ordinary skill in the art, the exemplary force signal profiles 301A-301D are disclosed by way of non-limiting examples.

In an embodiment, a fine grain force module 305 may provide a repetitive fine grain force signal 313E to node 327 to effect a granular tactile feedback to the operator of closely spaced (in angle), low amplitude detent notches relative to the amplitude of the primary force signal. The fine grain force module 305 may include receiving the rotor angular position signal (θ_{M}) as the dividend in a modulo function 305A. As an example, light detent notches spread evenly over one revolution every 5 degrees of rotation may be effected by division of the rotor angular position signal (θ_{M}) by 72 at the modulo function 305A, the modulo output (i.e., the remainder) of which may reference a fine grain force signal profile 305B (e.g., look-up table). The fine grain force signal profile 305B is thus a periodic function which repeats itself every 5 degrees of rotation to provide the fine grain force signal 313E to node 327 where it is subtracted from the primary force signal 313B.

In an embodiment, a dynamics force module 303 may provide a virtual dynamics force signal 317 to emulate desired feel to the human user 121 and response characteristics through the rotor 106 of the motor 102. In an embodiment, the dynamics force module 303 may include a virtual damping force module 303A, a virtual reaction force module 303B, a virtual mass module 303C and a virtual mass viscous damping module 303D. The virtual dynamics force signal 317 from the dynamics force module 303 may come from node 323 which sums a virtual damping force signal 330 from the virtual damping force module 303A and a virtual reaction force signal 331 from the virtual reaction force module 303B. The virtual mass module 303C may emulate a system mass and inertial characteristic corresponding to a moment of inertia (J), and the virtual mass viscous damping module 303D may emulate a system damping characteristic. The virtual reaction force signal 331 is needed as an inertia input to node 312 in the virtual mass module 303C and as tactile feedback to the human user 121 through node 323 as part of the virtual dynamics force signal 317. To detect this reaction force, a stiff modeled spring is introduced via a spring coefficient (K) at coefficient block 310 acting on the virtual inertia from the virtual mass module 303C. Whenever the angular position differs between the rotor angular position signal (θ_{M}) and a virtual mass angular position signal (θ) at node 308, the modeled spring is twisted and the difference (at node 308) which then develops (across the modeled spring) is proportional to a torque (i.e., virtual reaction force signal 331).

In an embodiment, the virtual damping force module 303A may receive the rotor angular position signal (θ_{M}) at differential block 302 to provide rotor angular velocity (ω_{M}) to node 304 which subtracts a virtual mass angular velocity (ω) from the virtual mass module 303C. The output from the node 304 is subjected to a respective damping coefficient (β) at coefficient block 306 to provide the virtual damping force signal 330 to node 323. The virtual damping force signal 330 dampens resonance between the virtual reaction force module 303B and the virtual mass module 303C but does not contribute to the feel to the human user 121 at the rotor 106. This damping is driven by the difference in angular velocity as determined by the difference between rotor angular velocity (ω_{M}) and virtual mass angular velocity (ω) from node 304.

In an embodiment, the virtual reaction force module 303B may receive the rotor angular position signal (θ_{M}) at node 308 whereat a virtual mass angular position signal (θ) from the virtual mass module 303C is subtracted. The output from the node 308 is subjected to a spring coefficient (K) at coefficient block 310 to provide the virtual reaction force signal 331 to nodes 312 and 323.

In an embodiment, the virtual reaction force signal 331 from virtual reaction force module 303B is provided to node 312. Node 312 subtracts a virtual mass viscous damping force 314 from the virtual reaction force signal 331 for input to the virtual mass module 303C. The virtual mass viscous damping module 303D provides the virtual mass viscous damping force 314 by subjecting the virtual mass angular velocity (ω) to a respective damping coefficient (β) at coefficient block 316. The viscous damping force 314 is what the human user 121 feels through the modeled spring in the virtual reaction force module 303B and provides the desired feel to the human user 121 and response characteristics of the system. The node 312 thus provides an input force to the virtual mass module 303C which is subjected to a moment of inertia inversion block 322 to provide a virtual mass acceleration 328. The virtual mass acceleration 328 is subjected to a respective integration at integration block 324 to provide the virtual mass angular velocity (ω). The virtual mass angular velocity (ω) is subjected to a respective integration at integration block 326 to provide the virtual mass angular position signal (θ).

Alternative system models and emulations to achieve a virtual dynamics force signal 317 may be apparent to those having ordinary skill in the art. The details of the dynamics force module 303 set forth herein are provided by way of non-limiting example.

The virtual dynamics force signal 317 may be subtracted from the primary force signal 313C to provide the driver 133 of the motor 102 with the motor torque signal T_{M}. Thus, electromotive force of the motor 102 may be generated based upon the primary force signal 313A and one or more of the virtual dynamics force signal 317, the haptic force signal 313D and the fine grain force signal 313A.

The terminology used herein is for the purpose of describing particular embodiments only and is not intended to be limiting. The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

All numeric values herein are assumed to be modified by the term “about” whether or not explicitly indicated. For the purposes of the present disclosure, ranges may be expressed as from “about” one particular value to “about” another particular value. The term “about” generally refers to a range of numeric values that one of skill in the art would consider equivalent to the recited numeric value, having the same function or result, or reasonably within manufacturing tolerances of the recited numeric value generally. Similarly, numeric values set forth herein are by way of non-limiting example and may be nominal values, it being understood that actual values may vary from nominal values in accordance with environment, design and manufacturing tolerance, age and other factors.

When an element such as a layer, film, region, or substrate is referred to as being “on” another element, it can be directly on the other element or intervening elements may also be present. In contrast, when an element is referred to as being “directly on” another element, there are no intervening elements present. Therefore, unless explicitly described as being “direct,” when a relationship between first and second elements is described in the above disclosure, that relationship may be a direct relationship where no other intervening elements are present between the first and second elements but may also be an indirect relationship where one or more intervening elements are present (either spatially or functionally) between the first and second elements.

One or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Unless defined otherwise, technical and scientific terms used herein have the same meaning as is commonly understood by one of skill in the art to which this disclosure belongs.

Unless specified to the contrary herein, all test standards are the most recent standard in effect as of the filing date of this application, or, if priority is claimed, the filing date of the earliest priority application in which the test standard appears.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A bi-directional human-machine interface, comprising:
an electric motor including a static component fixedly attached to a support and a dynamic component moveable with respect to the support;
a plurality of alignments of the dynamic component to the static component, wherein the alignments are visually discernable via alignment of a visible index on the dynamic component to respective visible indices on the support; and
a controller configured to provide an electromotive force from the static component to the dynamic component, the controller operable in a first mode to control the electromotive force effective to move the dynamic component toward a predetermined one of the plurality of alignments in response to a deviation of the dynamic component from the predetermined one of the plurality of alignments, and operable in a second mode to control the electromotive force effective to provide position stability and virtual detent tactile feedback to a human user corresponding to at least one of the plurality of alignments in response to a manual positioning of the dynamic component by the human user to the at least one of the plurality of alignments.

2. The bi-directional human-machine interface of claim 1, wherein the electric motor comprises a rotary electric motor.

3. The bi-directional human-machine interface of claim 1, wherein the electric motor comprises a linear electric motor.

4. The bi-directional human-machine interface of claim 1, wherein the plurality of alignments correspond to a plurality of automotive transmission settings and the predetermined one of the plurality of alignments corresponds to one of the plurality of automotive transmission settings activated by an autonomous driving system.

5. The bi-directional human-machine interface of claim 1, wherein the controller configured to provide the electromotive force comprises a primary force module providing a primary force signal, and wherein the electromotive force is provided based upon the primary force signal.

6. The bi-directional human-machine interface of claim 5, wherein the primary force module providing the primary force signal comprises a plurality of force signal profiles selectively invoked to provide the primary force signal.

7. The bi-directional human-machine interface of claim 6, wherein the plurality of force signal profiles comprises at least one respective force signal profile providing the primary force signal in the first mode in response to the deviation of the dynamic component from the predetermined one of the plurality of alignments.

8. The bi-directional human-machine interface of claim 6, wherein the plurality of force signal profiles comprises at least one respective force signal profile providing the primary force signal in the second mode in response to the manual positioning of the dynamic component by the human user to the at least one of the plurality of alignments.

9. The bi-directional human-machine interface of claim 5, wherein the controller configured to provide the electromotive force further comprises a dynamics force module providing a virtual dynamics force signal, and wherein the electromotive force is provided further based upon the virtual dynamics force signal.

10. The bi-directional human-machine interface of claim 9, wherein the dynamics force module providing the virtual dynamics force signal comprises a virtual mass viscous damping force module providing a virtual mass viscous damping force signal and a virtual reaction force module providing a virtual reaction force signal, and wherein the virtual dynamics force signal is provided based upon the virtual mass viscous damping force signal and the virtual reaction force signal.

11. The bi-directional human-machine interface of claim 5, wherein the controller configured to provide the electromotive force further comprises a haptic force module providing a haptic force signal in response to the manual positioning of the dynamic component by the human user, and wherein the electromotive force is provided further based upon the haptic force signal.

12. The bi-directional human-machine interface of claim 5, wherein the controller configured to provide the electromotive force further comprises a fine grain force module providing a fine grain force signal in response to the manual positioning of the dynamic component by the human user, wherein the electromotive force is provided further based upon the fine grain force signal.

13. A bi-directional human-machine interface, comprising:
a rotary electric motor including a static component fixedly attached to a support in a vehicle and a dynamic component rotatable with respect to the support;
a plurality of alignments of the dynamic component to the static component corresponding to a plurality of automotive transmission settings, wherein the alignments are visually discernable via alignment of a visible index on the dynamic component to respective visible indices on the support; and
a controller configured to provide an electromotive force from the static component to the dynamic component, the controller operable in a first mode to control the electromotive force effective to move the dynamic component toward a predetermined one of the plurality of alignments corresponding to one of the plurality of automotive transmission settings activated by an autonomous driving system in response to a deviation of the dynamic component from the predetermined one of the plurality of alignments, and operable in a second mode to control the electromotive force effective to provide position stability and virtual detent tactile feedback to a human user corresponding to at least one of the plurality of alignments in response to a manual positioning of the dynamic component by the human user to the at least one of the plurality of alignments.

14. The bi-directional human-machine interface of claim 13, wherein the controller configured to provide the electromotive force comprises a first force module providing a primary force signal and a second force module providing a virtual dynamics force signal, and wherein the electromotive force is provided based upon the primary force signal and the virtual dynamics force signal.

15. The bi-directional human-machine interface of claim 14, wherein the first force module providing the primary force signal comprises a plurality of force signal profiles selectively invoked to provide the primary force signal.

16. The bi-directional human-machine interface of claim 15, wherein the plurality of force signal profiles comprises at least one respective force signal profile providing the primary force signal in the first mode in response to the deviation of the dynamic component from the predetermined one of the plurality of alignments.

17. The bi-directional human-machine interface of claim 15, wherein the plurality of force signal profiles comprises at least one respective force signal profile providing the primary force signal in the second mode in response to the manual positioning of the dynamic component by the human user to the at least one of the plurality of alignments.

18. The bi-directional human-machine interface of claim 14, wherein the second force module providing the virtual dynamics force signal comprises a virtual mass viscous damping force module providing a virtual mass viscous damping force signal and a virtual reaction force module providing a virtual reaction force signal, wherein the virtual dynamics force signal is provided based upon the virtual mass viscous damping force signal and the virtual reaction force signal.

19. The bi-directional human-machine interface of claim 14, wherein the controller configured to provide the electromotive force further comprises a third force module providing a haptic force signal in response to the manual positioning of the dynamic component by the human user, wherein the electromotive force is provided further based upon the haptic force signal.

20. A bi-directional human-machine interface, comprising:
a rotary electric motor including a static component fixedly attached to a support in a vehicle and a dynamic component rotatable with respect to the support;
a plurality of alignments of the dynamic component to the static component corresponding to a plurality of automotive transmission settings, wherein the alignments are visually discernable via alignment of a visible index on the dynamic component to respective visible indices on the support; and
a controller configured to provide an electromotive force from the static component to the dynamic component, the controller operable in a first mode to control the electromotive force effective to move the dynamic component toward a predetermined one of the plurality of alignments corresponding to one of the plurality of automotive transmission settings activated by an autonomous driving system in response to a deviation of the dynamic component from the predetermined one of the plurality of alignments, and operable in a second mode to control the electromotive force effective to provide position stability and virtual detent tactile feedback to a human user corresponding to at least one of the plurality of alignments in response to a manual positioning of the dynamic component by the human user to the at least one of the plurality of alignments, the controller comprising:
a first force module including a plurality of selectively invoked force signal profiles providing a primary force signal, wherein the plurality of selectively invoked force signal profiles includes at least one respective force signal profile providing the primary force signal in the first mode in response to the deviation of the dynamic component from the predetermined one of the plurality of alignments and at least one respective force signal profile providing the primary force signal in the second mode in response to the manual positioning of the dynamic component by the human user to the at least one of the plurality of alignments;
a second force module providing a virtual dynamics force signal, wherein the second force module includes a virtual mass viscous damping force module providing a virtual mass viscous damping force signal and a virtual reaction force module providing a virtual reaction force signal, wherein the virtual dynamics force signal is provided based upon the virtual mass viscous damping force signal and the virtual reaction force signal; and
a third force module providing a haptic force signal in response to the manual positioning of the dynamic component by the human user;
wherein the electromotive force is provided from the static component to the dynamic component based upon the primary force signal, the virtual dynamics force signal and the haptic force signal.
